(19) United States
(12) Patent Application Publication
(10) Pub. No.: US 2015/0082693 A1
(43) Pub. Date: Mar. 26, 2015

(54) Multipurpose, Adjustable, Collapsible and Portable Stand

(71) Applicant: John Patrick Griffin, Sykesville, MD (US)

(72) Inventor: John Patrick Griffin, Sykesville, MD (US)

(21) Appl. No.: 14/494,885

(22) Filed: Sep. 24, 2014

Related U.S. Application Data
(60) Provisional application No. 61/881,540, filed on Sep. 24, 2013.

(51) Int. Cl. A01G 13/00; A01G 27/00

(52) U.S. Cl. CPC A01G 13/0206; A01G 27/00
USPC 47/21.1; 47/20.1

(57) ABSTRACT

A multi-faceted multi-task system for horticultural adaptations including water dispersion and irrigation, animal and plant/crop protection, and plant shading, which includes a multipurpose head that allows a user to operate an irrigation system or a radial misting apparatus while using a tarp for shade and construct a fence using the fence hooks to create an animal control zone. The present device features a telescoping main pole that can be adjusted to different heights to fit any situation. A PVC extension device is also included which allows the different system heads to be hoisted to additional heights not achievable by the stand alone. The device is highly portable as it can be folded up onto itself and carried to a destination by hand and provides water dispersion for irrigation and temperature control, while offering users the opportunity to construct a shade and/or animal control zone.

### CROSS REFERENCE TO RELATED APPLICATION

This application claims the benefit of and takes priority from U.S. Application number 61/881,540 filed on Sep. 24, 2013, the contents of which are hereby incorporated by reference.

### FIELD OF THE INVENTION

The present system and series of accompanying apparatuses relate to horticultural, assist systems, and particularly a water distribution, shade protection and animal protection system for the horticultural, agricultural and sports sectors to irrigate plants and gardens, regulate temperatures, and create control zones against animals.

### BACKGROUND OF THE INVENTION

There are a variety of devices that are known for dispersing water around an area and some include stands that may elevate a system head to provide a better radius of dispersion. Since the dawn of farming ten thousand years ago in the Neolithic era, the need to regularly and efficiently hydrate and nourish crops that have been planted has existed.

In the initial years, planting was intentionally situated in proximity to river beds where the water table was high enough to provide the proper amount of moisture. Additionally, the ancient Egyptians implemented a similar technique by planting with the flooding cycle of the mighty Nile River, allowing The Nile to supply both water and nutrients for their crops.

As farming became more heavily relied upon for survival of villages and nations alike, farmers started to move away from river beds and into fields making irrigation more important. Eventually, channels and aqueducts for diverting water from rivers and streams were created to water the farmland. Subsequently, via gravity and pumping devices, water pressure systems were designed to push water out of pipes, effectively creating the first system. Today systems are used for much more than just shuttling water to crops; it is also used to control temperatures of cattle, athletic participants, and crowds.

Concurrent systems for the dispersal of fluids in the areas of agriculture and grass growth can be classified into numerous categories. In some embodiments, a series or system of piping comprising a small diameter and a height normally less than four (4) feet, either staked into the ground or attached to a larger pipe. The systems in this category are often not portable because they are frequently in fluid communication, integrated into, or attached to rigid water lines, or deeply imbedded into the soil to provide the needed stability. Additionally, the height and positioning of these systems renders them at a disadvantage to disperse water over a larger area, making it necessary for multiple units to be used to cover a specific area. The low height of the systems in this category only work for small crops/plants and cannot be used to create cooling zones for athletes or livestock because the water is not dispersed high enough and/or in a controlled consistency and volume to be effective.

Another category of water system systems may be classified as large movable apparatuses on wheels possessing the ability to discharge large amounts of water at high pressure out of a pivoting metal nozzle. This type of fluid dispersal system is adequate at covering large swaths of land with adequate amounts of water but there are several drawbacks. The high pressure of the system renders this system unusable for lawn and athletic venues as well as agricultural use in cattle yards and newly seeded plots or patches where delicate plants are growing, as the large amounts of water will create muddy, saturated and potentially unsanitary areas for cattle and drown or damage plants. The portability of these systems is limited because of their bulkiness and can only be moved by a motorized vehicle, making placement of the system limited to areas cleared to allow vehicles access.

An additional category of systems includes large mechanized rolling water disbursement platforms that are either attached to a central location or move freely along a preplanned route. These systems are designed to function in large acreage farms and are not portable, as they must be assembled and disassembled on location. This category delivers water through hanging tubes or pipes that mist plants from above. It is not practical for anything other than watering crops.

The final category discussed herein includes systems more akin to the instant fluid dispersal and horticultural protection systems that can be grouped into small ground based systems that are portable. These systems include the typical residential lawn dispersal system, crowd misters, or other small pivoting water dispersion devices. These are often used to water residential lawns and small gardens or cool crowds and athletes, and due to the units being ground based they cannot get the same trajectory as taller systems that cover a greater area and are not blocked by low obstacles. A water dispersion system that may be easily transported, may be adjusted to great heights, may provide coverage for large areas, and does not need to be towed to locations or mechanized for operation is vital.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses for creating and utilizing a series of systems and apparatuses comprising of a fluid dispersal system which additionally encompasses additional protection from animals and the elements are illustrated. Thus the several embodiments of the instant apparatus are illustrated herein.

It is therefore an objective of the instant system to create a fluid dispersal and temperature cooling environment via the dispersion of water to satisfy irrigation and plant protection needs for horticultural purposes.

It is therefore an objective of the instant system to create a fluid dispersal and temperature cooling environment via the dispersion of water to satisfy temperature and animal protection needs for agriculture purposes.

It is also an objective of the instant system to introduce a free standing, adjustable mechanism to provide water dispersion, a shade zone, and an animal and/or plant protection system in the same device.

An additional objective of the instant system is to provide adequate irrigation for plants/crops by a system with head(s) situated on top to spray water down/across onto plants by introducing a multipurpose adjustable pole, constructed of a metal alloy, has two parts main pole and the secondary pole which fits inside the main pole and can be heightened or lowered via a push pin mechanism or a key slot connector that is integrated with a corresponding aluminum profile channel pipe mentioned hereinafter that secures the two poles together.

Additionally, it is the object of this system to have a multipurpose head situated on top of the adjustable stand. The multipurpose head will have a threaded bolt welded to it where different heads and a PVC pipe extender can be anchored. It is a further object of the instant apparatus to provide a shade zone via a tarp or shade cloth. The tarp would be secured by threading the multipurpose head's threaded screw through the eyelet hole of the tarp, and secured with a wing nut. The various distribution heads can be attached along with the tarp by securing the tarp first and then threading a system head onto the welded threaded bolt to secure it. The multipurpose head also has the purpose of providing a way to secure a fence to create a barrier against animals. A single or multi-pronged hook is affixed to the head of the present apparatus to allow for easy hook up and a fence can be attached to another unit or holding device. In another embodiment, the aforementioned secondary pole may be comprised of an aluminum profile channel pipe that will allow for precise location, height and/or direction of the associated cap accessories as described hereinafter.

It is also an additional object of the instant system to introduce, in one embodiment, a spring system, either a single or dual spring configuration, normally located at the base of the adjustable pole. The springs will be anchored by a C-bracket to the base of the adjustable pole and to the structural support system. The present invention's structural support system has four pivoting legs that extend out and fold back towards the main body of the stand. This spring mechanism allows the unit to stand up to high winds and impacts, as the force of either will be dampened by the spring mechanism and the force diminished to the point that it will not knock over or compromise the stability of the unit. In another embodiment the concurrent device would not have a spring apparatus at its base, but instead the telescoping pole would be bolted directly to the legs C-brackets.

Moreover, the instant system applies to differing forms and attachments in order to create advantageous and/or appealing user applications within numerous prescribed industries. Some examples may include, but are in no way limited to, design and/or attachment variances in order to obtain angle, height and/or tool application attachment advantages and/or uses such as, but in no way limited to video cameras, picture cameras, lightening detection devices, lights, motion detection devices, boundary/perimeter sensor devices, radar, weather sensing devices.

These together, with the other objectives of the device, along with the various features of novelty, which characterize the apparatus, are pointed out with particularity in the claims annexed to and forming a part of this disclosure. For a better understanding of the mechanism, its operating advantages, and the specific objectives attained by its use, study of the accompanying drawings and descriptive matter, in which there are illustrations of the preferred embodiments, should be conducted.

There has thus been outlined, rather broadly, the more important features of the versatile integrated system, and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a front view illustrating an exploded view of the multipurpose head stationed atop of the adjustable telescoping pole.

FIG. 2 illustrates a side perspective view illustrating an exploded view of one embodiment of the multipurpose head supporting a tarp or other cover/protective mechanism.

FIG. 3 illustrates a side perspective view of the upper portion of the instant system illustrating the entire device showing the multipurpose head in use, the main pole adjusted to one of its height positions, the spring mechanism, and the collapsing legs.

FIG. 4 illustrates a side perspective view of the upper portion of the instant system including the PVC extender with a radial mister fastened onto the threaded portion of the bolt mount and flat base.

FIG. 5 illustrates a side perspective view of the entirety of the instant system illustrating the spring mechanism attached to the main pole, further illustrating the folding or collapsible legs or arm mechanisms.

FIG. 6 illustrates a front view illustrating the series of holes or apertures in the lower pole that are designed to hold the push pin and the pushpin located in one of the apertures or holes.

FIG. 7 illustrates a top perspective view of the bottom portion of the main pole illustrating the spring system and legs wherein the spring system consists of a duel industrial strength springs that are positioned upright and bolted to the lower portion of the main pole by two L-brackets.

FIG. 8 illustrates a top perspective exploded view of the bottom portion of the main pole attached to the spring mechanism and collapsible legs.

FIG. 9 illustrates a front view illustrating the multipurpose interchangeable head, not attached to the stand and further illustrates the cap head which includes a slightly larger hollow cavity to allow the top portion of the main pole to be inserted into the cap head.

FIG. 10 illustrates a side view of multipurpose interchangeable head, not attached to the stand and further illustrates the cap head which includes a slightly larger hollow cavity to allow the top portion of the main pole to be inserted into the cap head.

FIG. 11 illustrates a front view of one embodiment of the aluminum extrusion post of the instant system illustrating an attached sprinkler apparatus and an eyebolt mechanism of for attachment of tarp or netting systems.

FIG. 12 illustrates an exploded front view of one embodiment of the aluminum extrusion post of the instant system illustrating an attached sprinkler apparatus and an eyebolt mechanism of for attachment of tarp or netting systems.

### DETAILED DESCRIPTION OF THE INVENTION

The detailed description set forth below is intended as a description of presently preferred embodiments of the invention and does not represent the only forms in which the instant invention may be construed and/or utilized. However, it is to be understood that the same or equivalent functions may be accomplished by different embodiments and are also intended to be encompassed within the scope of the invention. The multipurpose horticultural, agricultural and sports adjustable, collapsible and portable stand may be referred to as the “system.”

The system is designed to uniquely satisfy four (4) critical criteria as a horticultural, agricultural and/or sport system, that includes being wholly collapsible, portable, adjustable and simultaneously multipurpose. First, the system is designed to be collapsible in order to afford the user ease of transport and storage, while fitting into a minimal area. In one embodiment, the four (4) base legs which may be of 5.5′ each and the telescopic pole, which may be fully lowered to approximately 7′ to fully heightened approximately 10′, may utilize a push pin mechanism to fold up/down in order to become a uniform parallel unit or by means of an aluminum profile channel post utilizing a nut or corresponding key slot connector in order to achieve precise height, direction and/or location requirements.

Second, the system is designed to be portable in order to allow the unit to be transferred to a specific location as it relates to satisfying a unique need within that environment in a timely and cost efficient manner. Of great importance here, the system can be specific and customized into an environment; hence, the system is a practical and efficient means to save time and ultimately costs.

Third the instant system is designed to be adjustable in numerous embodiments, including heightening requirements as it relates to irrigation/water distribution, shade protection and/or fencing height related to an asset deterrent barrier. The means by which the height is adjusted is a push pin mechanism and/or hand tightening bolt device or key slot connector if utilizing an aluminum profile channel pipe as the upper main post. The push pin is engaged by a single finger to a fully lowered through fully heightened position or single hand to loosen and/or tighten the hardware associated with the key slot connector in order to increase or decrease pressure in order to increase or decrease post height. In one embodiment, the lowered height may range from approximately 7′, 8′, 9′ and fully heightened may reach approximately 10′ or more.

Fourth, the system may comprise a simultaneous use multipurpose head unit to perform as an irrigation/water distribution, shade protection, and barrier/deterrent unit individually, dually and/or all inclusively by means of a uniquely designed head that may be welded and secured to the top of the telescopic tube or pole type mechanism or attached individually into a channel if utilizing a four channel upper main post by utilizing the hardware associated with a key slot connector in order to achieve precise height, direction and/or location requirements and individual or multi head requirements.

The ability to easily and rapidly exchange out the cap heads of the instant system affords the user to customize the individual system to meet and satisfy their specific needs and requirements expeditiously. In the instant system, the cap heads may possess varying intended purposes and directives, relative to irrigation, deer fence and/or shade cloth uses and/or attachment variances in order to obtain angle, height and/or tool application attachment advantages and/or uses such as, but in no way limited to video cameras, picture cameras, lightening detection devices, lights, motion detection devices, boundary/perimeter sensor devices, radar, weather sensing devices. Herein, a list of exemplary cap head designs and configurations, not to be construed as limiting, that may serve to satisfy a matrix of irrigation, deer fence and/or shade cloth requirements is as follows:
1. Deer Fence—multiple hooks integrated into the cap head by means of fabrication, welding and/or hardware such as, but in no way limited to, nuts, bolts and/or hand tightening devices.
2. Irrigation—male/female threaded connectors integrated into the cap head to adequately receive various sprinkler heads and water sources such as, but in no way limited to, a typical garden hose, pvc pipe, steel pipe, copper pipe. The means to integrate the aforementioned connectors into the cap head will be by fabrication, welding and/or hardware such as, but in no way limited to, nuts, bolts and/or hose clamps.
3. Shade Cloth—A threaded rod of approximately ⅜″ with a washer to properly receive and suspend a shade cloth by means of typical grommets. The means to secure the shade cloth's grommet to the threaded rod will be, but in no way limited to, an appropriately sized wing nut.

The below list represents, but is not limited to, the matrix of cap head design variations to satisfy single, dual and tri-system configurations as follows:
1. Deer Fence
2. Irrigation
3. Shade Cloth
4. Deer Fence and/or Irrigation
5. Deer Fence and/or Shade Cloth
6. Irrigation and/or Shade Cloth
7. Deer Fence and/or Irrigation and/or Shade Cloth

Each of the following cap head designs will be designed and constructed to satisfy change of direction layouts such as corners and other varying degree angles.

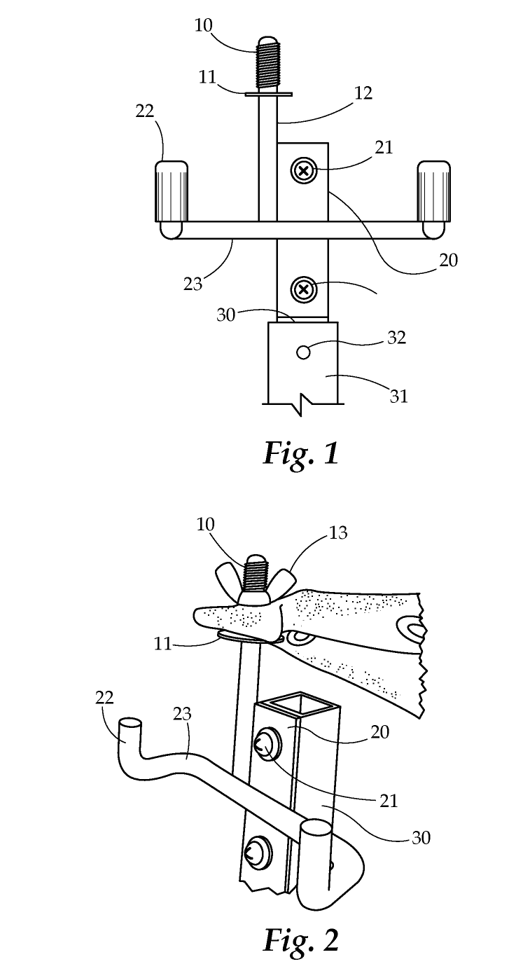

FIGS. 1-4 depict various viewpoints of the present apparatus's multipurpose head that is stationed atop of the smaller top portion of the telescoping pole 30. The multipurpose head has a threaded bolt mount 10 which is designed to receive different types of system heads like a percussion head 40 and a radial mister 41. The threaded bolt mount 10 has a small flat base 11 welded onto it to ensure the attachments stay in place. Below the flat base 11 exists the smooth portion of the bolt mount 12 which is welded on its side to the metal holding bracket 20. The holding bracket 20 also has a hook arm 23 welded onto its front side. The hook arm extended outward and then bends forward slightly and then upwardly to form two hooks 22 which may comprise tips 90, which may be made of rubber, polymer, composite or other materials. The purpose of the two (2) yellow hooks is to secure specialized fence/tarp related to an end user's customized boundary barrier deterrent device in order to protect assets. Also utilized may be a threaded bolt with a welded washer is to secure a grommet fixed to shade cloth, tarps and the like in order to protect people and/or assets such as animals and items that need to remain relatively dry in a given time frame.

Further, the threaded bolt may be utilized to secure an irrigation/water distribution unit to the system, by securely fastening a matching long nut to the irrigation/water distribution head. If both a shade cloth/tarp and an irrigation/water distribution unit are being used simultaneously, then the long nut associated with the irrigation/water distribution unit will be the means to secure the shade cloth/tarp to the System.

In one embodiment, a shade cloth/tarp may be used separate from the irrigation/water distribution unit and such an embodiment, a wing nut may be utilized for ease of use by hand and to insure that the shade cloth/tarp remains secure to the bolt. The holding bracket 20 may be fastened by two screws 21 onto the upper portion of the telescoping pole 30.

FIG. 2 depicts one embodiment of the multipurpose head supporting a tarp or other cover/protective mechanism. The tarp is secured by placing the threaded portion of the bolt mount 10 through one of the tarp's eyelets and fastened into place by tightening a wing nut 13 over the top and compressing the tarp between the wing nut 13 and the flat base 11.

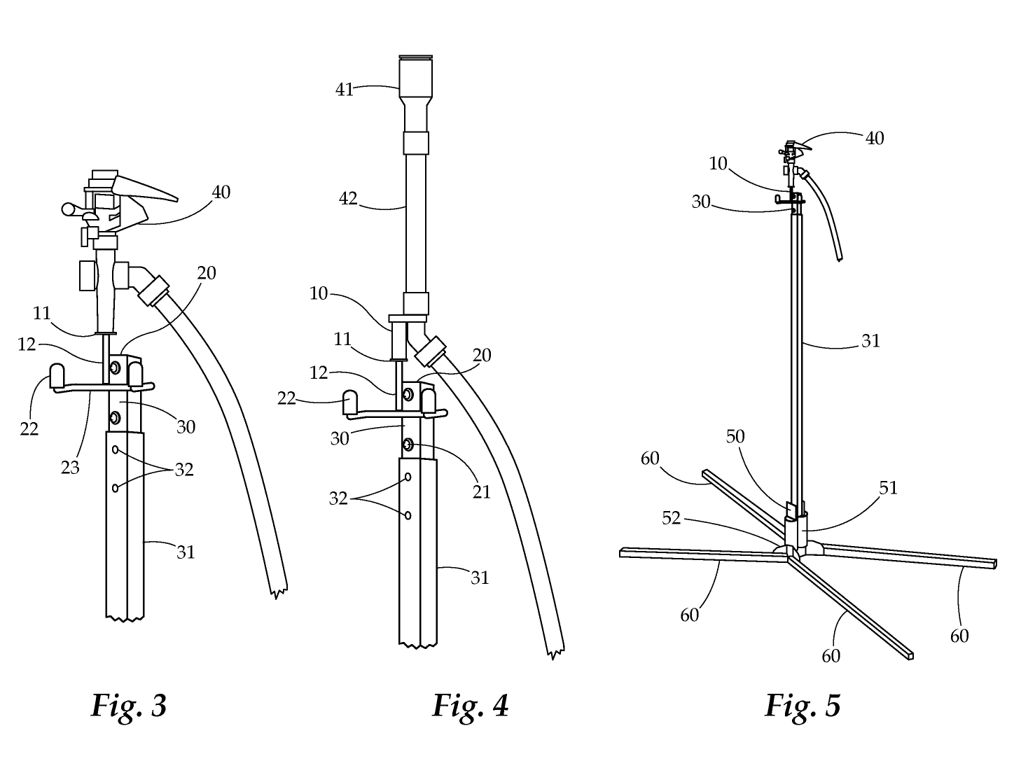

FIG. 3 illustrates the fully equipped device showing the multipurpose head in use, the main pole 30, 31 adjusted to one of its height positions, and further illustrates the spring mechanism and the collapsing legs.

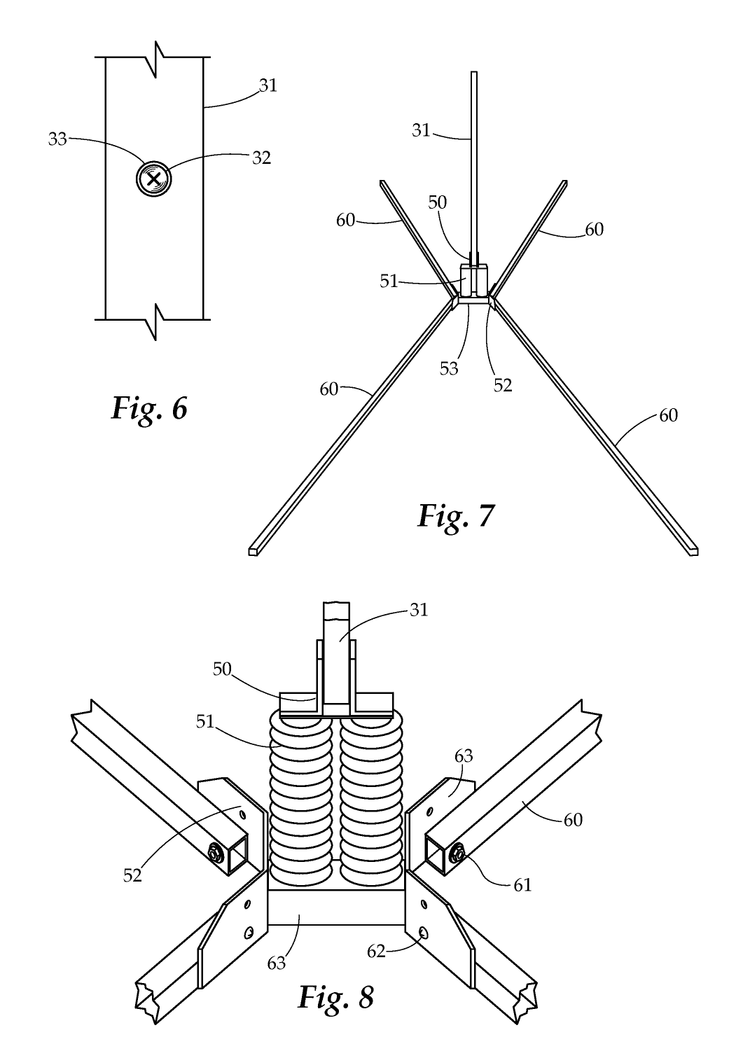

FIG. 4 shows the PVC extender 42 with a radial mister 41 fastened onto the threaded portion of the bolt mount 10 and flat base 11. There are a series of holes 32 in the lower pole 31 that are designed to hold the push pin 33 in place. There are a series of holes 32 in the lower pole 31 that are designed to hold the push pin 33 in place. FIG. 6 shows the pushpin 33 located in one of the apertures or holes 32.

FIG. 5 shows the two portions of the main pole; a smaller upper pole 30 which fits inside the larger lower pole 31. Both portions will be constructed of a metal alloy that is strong and light enough to be portable.

FIGS. 7-8 feature the spring system and legs 60 of the preferred embodiment. The spring system consists of a duel industrial strength springs 51 that are positioned upright and bolted to the lower portion of the main pole 31 by two L-brackets 50. The bottom of the duel springs are accorded to a metal base 53. The metal base 53 has C-brackets 52 bolted or welded to both ends. The C-brackets hold the stabilizing mechanism of the present device. There are two legs 60 bolted to each inside of the C-bracket. The bolt 61 used is designed to allow a pivoting motion, that would let the legs fold back towards the main pole 31.

In another embodiment, the legs 60 and base structure 53 would be bolted or welded directly to the lower pole 31 without the springs 51. There also exists the possibility that the present apparatus would only have one spring instead of the two springs 51 shown. The legs 60 would still pivot towards the main pole so it can be stored or transported. The legs 60 will be held in place when extended or retracted by a pushpin 62 that fits into a top and bottom hole 63 in the C-bracket 52.

In additional embodiment illustrating a means to secure the head to the post, an alternative method may comprise utilization of a “cap head” tube (which may comprise approximately 5″-6″ in length) with interior dimensions adequately larger than the exterior dimensions of the top of the extendible/retractable tube, in order to allow the cap head to freely slide over the post top but still maintain sound vertical integrity.

One manner in which to secure the cap head to the post top may include, but in no way limited to, a hitch pin in conjunction with a series of aligned holes between the cap head and post top. The post top may be aligned with cap head holes, which may be drilled on all four (4) sides, in order that the cap head may be easily and rapidly adjusted without having to adjust the entire post and/or exchange different purpose cap heads depending on its intended purpose relative to the site conditions.

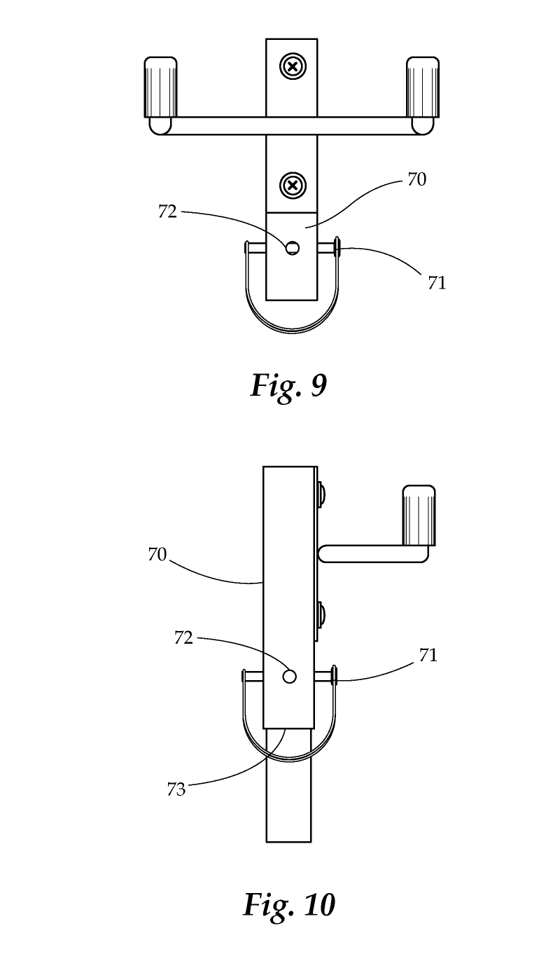

FIGS. 9-10 show another embodiment where there will be interchangeable heads that work for different functions. The interchangeable heads would serve the same functions as the multipurpose head described herein, but would be attachable and removable if the need arose to change the function of the present apparatus. The cap head 70 is a short metallic rectangular pole that has its bottom open. The cap head has a slightly larger hollow cavity 73 to allow the top portion of the main pole 30 to be inserted into it. There exists an aperture or hole 72 on each side of the cap head which corresponds with a hole in the top portion of the main pole 30. To secure the interchangeable heads a pin 71 is inserted through the aperture or hole 72 in the cap head 70 and its corresponding hole in the top portion of the main pole 30. The holes on each side of the cap head and main pole allow for a change in angle of use without having to adjust the whole apparatus.

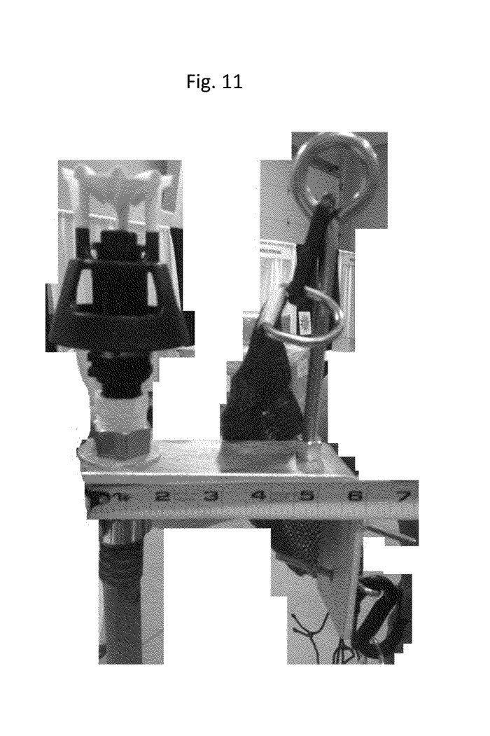

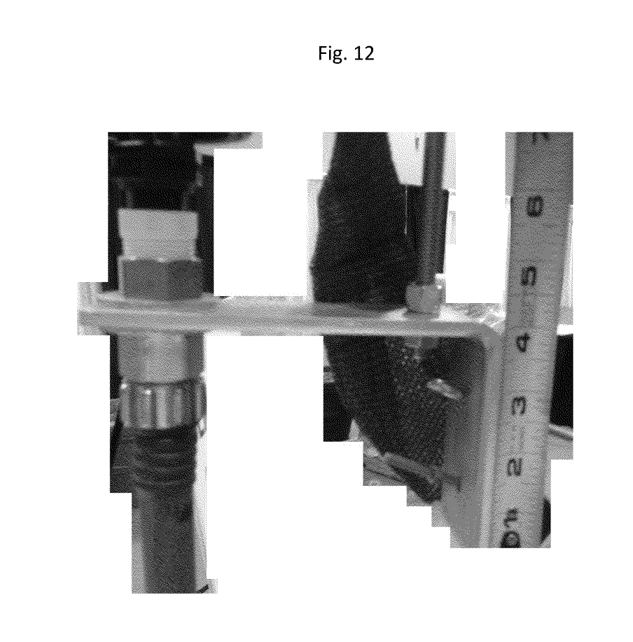

FIGS. 11-12 illustrate front views of one embodiment of the aluminum extrusion post of the instant system illustrating an attached sprinkler apparatus and an eyebolt mechanism of for attachment of tarp or netting systems.

In addition to the above mentioned means to adjust the main post height and secure the cap heads to the top of the post, an alternative method will be to utilize an aluminum extrusion post or aluminum profile channel post as the top male portion of the main post. As illustrated in FIGS. 11 and 12, the aluminum extrusion post or aluminum profile channel post is manufactured such that all four sides have a track that allows a nut or key slot connector to slide into the track and tightening pressure from a corresponding bolt size will secure the post in a precise and rapid manner.

The ability to utilize an aluminum (or other such commensurate material) extrusion post or aluminum profile channel post as the top male portion of the main post, coupled with proper sizing nuts and bolts or key slot connectors integrated into the post, in conjunction with each of the differing cap head(s) allows the end user to perform the required functions as follows:
1. Rapidly, easily and precisely set the height of the top portion of the main post with no limitations except to the length of the top post.
2. Rapidly, easily and precisely change the height of add, omit, exchange, change direction and/or angles of the cap head with no limitations except to the length of the top post.
3. Precisely integrate, and facilitate multipurpose use of, the cap heads while the cap heads may reside within an individual and/or separate post tracks and/or the same post track.

Furthermore, the value associated with the ability to easily, rapidly and precisely adjust the main post height and easily, rapidly and precisely change the height of, add, omit, exchange, change direction and/or angles of the cap head(s) by utilizing an aluminum extrusion post or aluminum profile channel post as the top of the main post is of great value and may be applied to yet to be determined uses and industries. The ability to integrate multiple cap end users with the described post is not limited to the horticulture, agriculture, viticulture, landscaping and/or sports industries, but will be applied in other industries where the described posts are coupled with the ability to rapidly, easily and precisely integrate varying end user specific cap heads such as, but not limited to video cameras, picture cameras, lightening detection devices, lights, motion detection devices, boundary/perimeter sensor devices, radar, weather sensing devices.

There has thus been outlined, rather broadly, the more important features of this versatile system in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

I claim:

1. A multipurpose, collapsible, and portable fluid dispersion unit comprising:
a pole mechanism comprising an upper portion and a lower portion wherein the upper portion diameter is smaller diameter than the lower portion diameter;
a spring system attached to the lower portion of the pole mechanism;
a stabilization system that is attached to the bottom end of the spring mechanism;
multipurpose heads that attach to the top portion of the pole mechanism;
a base mechanism;
a height extension device;
an irrigation apparatus
a fence apparatus; and,
a shade cloth apparatus.

2. The multipurpose, collapsible, and portable fluid dispersion unit of claim 1 wherein the pole mechanism comprises an upper pole portion and a lower pole portion wherein the upper pole portion is smaller and shorter that the lower pole to allow the smaller portion to fit inside the larger portion of the pole mechanism allowing for height adjustments.

3. The multipurpose, collapsible, and portable fluid dispersion of claim 1 wherein the pole mechanism further comprises multiple apertures in the lower portion of the pole mechanism and a push pin mechanism in the upper portion, wherein the push pin mechanism fits snuggly into the corresponding apertures in the lower portion of the pole mechanism and wherein an aluminum extrusion post or aluminum profile channel post comprising a nut and handle bolt or key slot connector is utilized to achieve precise height requirements.

4. The multipurpose, collapsible, and portable fluid dispersion of claim 1 wherein the entire pole mechanism is constructed of materials selected from the group of consisting of composites, metal alloys, carbon fiber, metallic material, plastic, polymers.

5. The multipurpose, collapsible, and portable fluid dispersion unit of claim 1, wherein the spring system configuration is selected from the group consisting of a single spring system, a dual spring system and a tri-spring system and wherein the spring system comprises a graded metallic material for industrial strength, in communication with an upper portion of the top by two L-brackets that are bolted to the lower portion of the pole mechanism and a lower metal alloy base securing the bottom of the spring.

6. The multipurpose, collapsible, and portable fluid dispersion unit of claim 1, wherein the stabilization system further comprises a set of legs comprising a set of apertures wherein the legs are pivotally attached to a set of C-brackets.

7. The multipurpose, collapsible, and portable fluid dispersion unit of claim 6, wherein the set of legs may be selected from the group consisting of two legs, three legs, and four legs.

8. The multipurpose, collapsible, and portable fluid dispersion unit of claim 7 further comprising a push pin mechanism wherein the arms are configured to pivot upwards toward the top of the pole mechanism and wherein the arms are secured in a closed position and an open position by the pushpin mechanism; and, wherein the pushpin mechanism is secured in the set of apertures in the legs and configured to fit snuggly into a set of apertures in the C-brackets.

9. The multipurpose, collapsible, and portable fluid dispersion unit of claim 1 wherein the multipurpose head further comprises:
a threaded bolt mount wherein;
a hook arm;
a holding bracket; and,
a metallic sleeve mechanism.

10. The multipurpose, collapsible, and portable fluid dispersion unit of claim 9 wherein the threaded bolt mount is welded to the holding bracket and further comprises a base device attached to the threaded bolt mount wherein the shape of the base is selected from the group consisting of disk shaped, rectangular, triangle, elliptical, trapezoidal, pentagonal, hexagonal, rhombus shaped, circular, spherical and semi-spherical.

11. The multipurpose, collapsible, and portable fluid dispersion unit of claim 9 further comprising a shade cloth apparatus wherein the threaded bolt mount is used to secure the shade cloth apparatus with a fastener chosen from the group consisting of a wing nut, a height extension device, and a system head.

12. The multipurpose, collapsible, and portable fluid dispersion unit of claim 9 wherein the hook arm is welded to the holding bracket and extends outwardly from each end, and wherein the hook arm extends upwardly at the end forming a set of hooks further comprising protective covers on the ends of the set of hooks.

13. The multipurpose, collapsible, and portable fluid dispersion unit of claim 12 wherein the protective covers may be selected from the group consisting of polymer, rubberized, composite, metal and alloy.

14. The multipurpose, collapsible, and portable fluid dispersion unit of claim 9 wherein the holding bracket comprises a front portion wherein the set of hook arms are welded onto the front portion of the bracket and the threaded bolt mount is welded onto its side.

15. The multipurpose, collapsible, and portable fluid dispersion unit of claim 9 wherein the top portion of the pole mechanism comprises an upper portion and wherein the upper portion comprises a set of screws on its front face.

16. The multipurpose, collapsible, and portable fluid dispersion unit of claim 9 further comprising a height extension device comprising a pipe mechanism constructed of polyvinyl chloride (PVC), and is anchored on the threaded bolt mount.

17. A multipurpose horticulture apparatus comprising:
a movable base apparatus;
a pole mechanism;
a netting apparatus;
a shading apparatus; wherein the netting apparatus and the shading apparatus are detachable to the base apparatus; and,
a set of detachable interchangeable heads.

18. The multipurpose horticulture apparatus of claim 17 further comprising a cap head comprising of a short metallic rectangular pole comprising an open bottom, wherein the cap head further comprises a slightly larger hollow cavity to allow the top potion of the main pole to be inserted into the cap head.

19. The multipurpose horticulture apparatus of claim 17 further comprising:
a netting apparatus; and,
a shading apparatus; wherein the netting apparatus and the shading apparatus are detachable to the base apparatus.

20. A multipurpose horticulture apparatus of claim 17 further comprising:
a movable base apparatus;
a pole mechanism;
a netting apparatus;
a shading apparatus; wherein the netting apparatus and the shading apparatus are detachable to the base apparatus;
a set of detachable interchangeable heads;
a pole mechanism; and,
an aluminum extrusion post comprising a nut and handle bolt; wherein the aluminum extrusion post is utilized to achieve precise height requirements.
